(19) United States
(12) Patent Application Publication
(10) Pub. No.: US 2008/0217403 A1
(43) Pub. Date: Sep. 11, 2008

(54) SYSTEM AND METHOD FOR LOGGING ELECTRONIC IMAGES

(76) Inventor: LOUIS ORMOND, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/684,392

(22) Filed: Mar. 9, 2007

(51) Int. Cl. G06F 19/00

(52) U.S. Cl. 235/385

(57) ABSTRACT

The subject application is directed to a system and method for logging electronic images. Receipt of a plurality of electronic images prompts the generation of unique tag data associated with each received electronic document. Each unique tag data includes data identifying the electronic document associated with the tag. Each of the documents is then monitored for the occurrence of an event. In the event that an event occurs, event data is generated. A data log is then generated including the tag data and the event data corresponding to received electronic documents. Thereafter, the log data is output.

### BACKGROUND OF THE INVENTION

The subject application is directed to a system and method for logging electronic images. More particularly, the subject application is directed to a system and method for generating and logging information that allows for tracking electronic documents.

Business environments employ electronic documents in many forms, including text files, vector files, and image files. Electronic documents arise from incoming facsimile transmissions, electronic mail, uploads, downloads, or scans. Additionally, electronic documents can be generated by applications, such as CAD packages, drawing packages, word processing packages, and the like.

Given the large number of electronic documents, along with the variety of formats in which they can be found, many systems for management or tracking of such documents or events associated with such documents exist. Conventional document tracking systems may generate information associated with an activity or event. Such information may be captured into a log file that is sent to or accessible by one or more users, such as a system administrator.

Events that may generate a log can include those such as printing, copying, scanning, transmission, modification, or the like. When a log file is created, it is frequently devoid of information regarding a particular document's location to allow for subsequent identification, retrieval, or analysis.

### SUMMARY OF THE INVENTION

In accordance with one embodiment of the subject application, there is provided a system and method for logging electronic images.

Further, in accordance with one embodiment of the subject application, there is provided a system and method for generating and logging information that allows for tracking electronic documents.

Still further, in accordance with one embodiment of the subject application, there is provided a system and method that will allow a document processing device to associate log events with related data, wherein the device is able to generate a uniform resource indicator based on certain parameters set on the device to point to any associated data.

Still further, in accordance with one embodiment of the subject application, there is provided a system and method wherein a document processing device is able to publish and store log and image data. The system and method allow an administrator or other user to trace user activity to extract image data related to such activity.

Further, in accordance with one embodiment of the subject application, there is provided an electronic image logging system. The system comprises means adapted for receiving a plurality of electronic documents. The system also comprises tag generation means adapted for generating unique tag data associated with each received electronic document, wherein each unique tag data includes data identifying an electronic document associated therewith. The system further comprises monitoring means adapted for monitoring an event associated with each of the plurality of electronic documents and means adapted for generating event data in accordance with an output of the monitoring means. The system also includes means adapted for generating a data log inclusive of tag data and event data corresponding to a plurality of received electronic documents and events associated therewith and output means adapted for outputting log data.

In one embodiment of the subject application, the monitoring means includes means adapted for monitoring usage that includes access to received electronic documents inclusive of electronic images. Preferably, the monitoring means further includes means adapted for monitoring usage that includes output of received electronic images to an associated document processing device.

In another embodiment of the subject application, the system further comprises analyzing means adapted for analyzing the data log in accordance with selected parameters to determine acceptability of usage. Preferably, the system further comprises means adapted for generating a notification signal upon a determination of unacceptable usage by the analyzing means.

In a further embodiment of the subject application, the system further comprises means adapted for periodically archiving a generated data log.

In yet another embodiment of the subject application, the tag data includes data representation of a storage location of an electronic document associated therewith.

Still further, in accordance with one embodiment of the subject application, there is provided a method for logging electronic images in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the electronic image logging system according to one embodiment of the subject application;

FIG. 2 is a block diagram illustrating controller hardware for use in the electronic image logging system according to one embodiment of the subject application;

FIG. 3 is a functional diagram illustrating the controller for use in the electronic image logging system according to one embodiment of the subject application;

FIG. 4 is a diagram illustrating a server for use in the electronic image logging system according to one embodiment of the subject application;

FIG. 5 is a flowchart illustrating a method for logging electronic images according to one embodiment of the subject application; and

FIG. 6 is a flowchart illustrating a method for logging electronic images according to one embodiment of the subject application.

### DETAILED DESCRIPTION OF THE PREFERRED EMBODIMENT

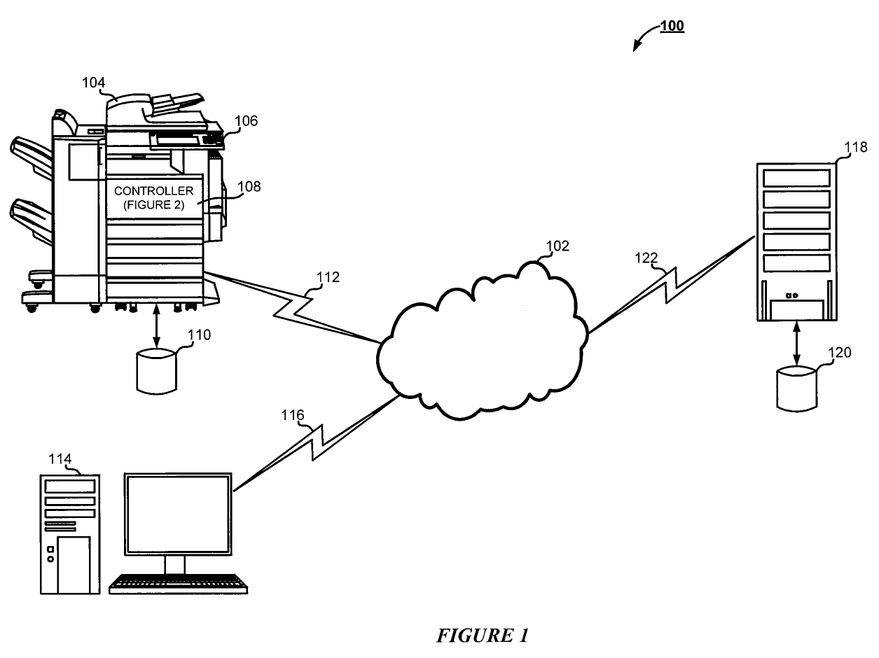

The subject application is directed to a system and method for logging electronic images. In particular, the subject application is directed to a system and method for generating and logging information that allows for tracking electronic documents. More particularly, the subject application is directed to a system and method that will allow a document processing device to associate log events with related data, wherein the device is able to generate a uniform resource indicator based on certain parameters set on the device to point to any associated data. In accordance with one embodiment of the subject application, there is provided a system and method wherein a document processing device is able to publish and store log and image data. The system and method allow an administrator or other user to trace user activity to extract image data related to such activity. It will become apparent to those skilled in the art that the system and method described herein are suitably adapted to a plurality of varying electronic fields employing data logs, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for logging electronic images in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Further, in accordance with another embodiment of the subject application, the document processing device 104 is suitably adapted to generate, maintain, and analyze log data corresponding to received electronic documents and images. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

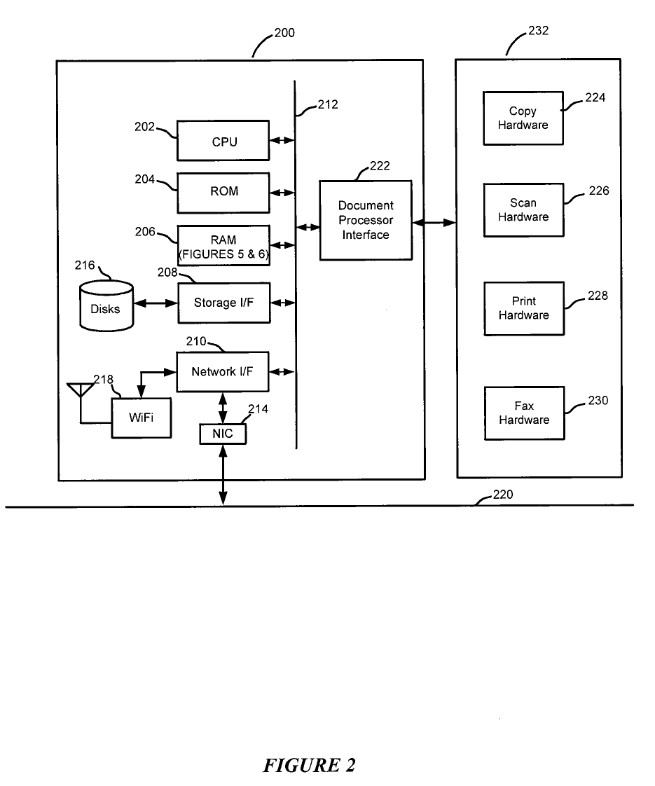

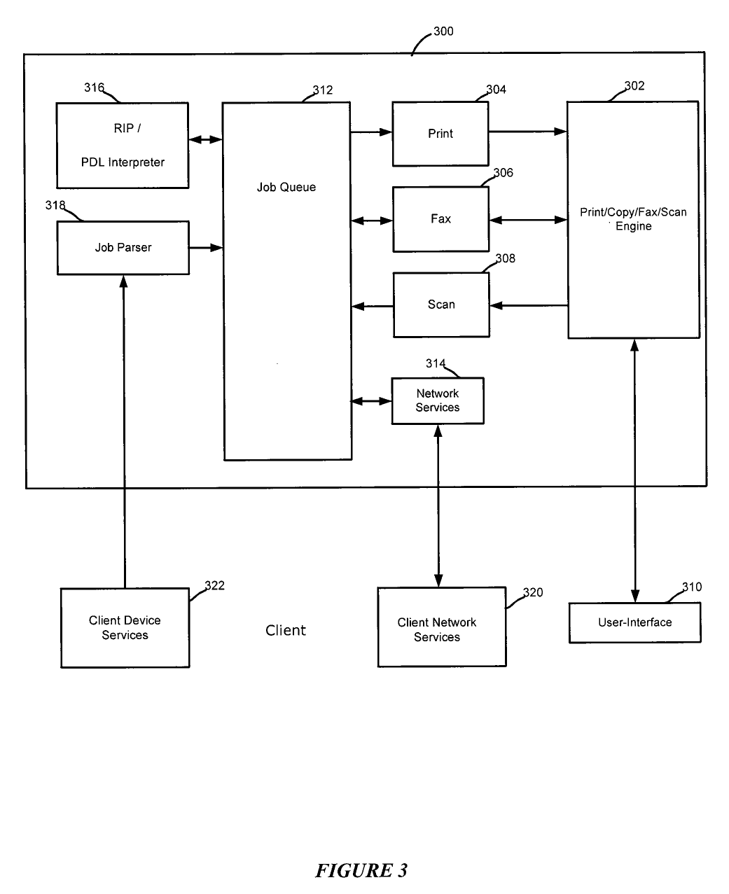

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the electronic image logging system and method of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store event data, document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data stored on the storage device 110 employs unique tags associated with each received electronic document, which identify the documents to which they are associated.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

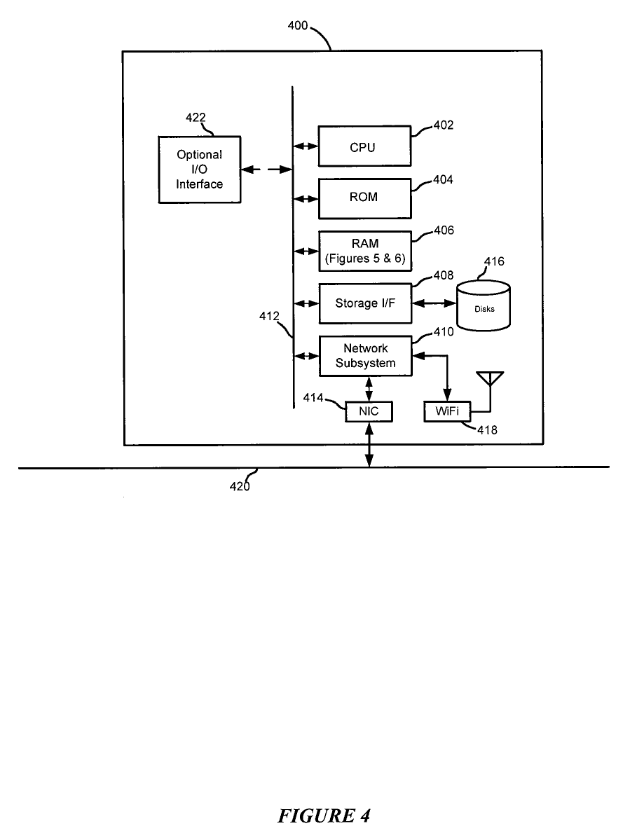

The system 100 further illustrates a network server 118 coupled to a data storage device 120. Preferably, the network server 118 is representative of any network storage device known in the art capable of storing document data, image data, video data, sound data, multimedia data, or other suitable electronic data, as will be known in the art. In accordance with one embodiment of the subject application, the data storage device 120 includes a plurality of electronic data, including image data, document data, archived data logs, tag data, event data, or the like. The network storage server 118 is communicatively coupled to the computer network 102 via a suitable communications link 122. As will be understood by those skilled in the art, the communications link 122 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art. The operation of the network server 118 will be better understood in conjunction with the block diagram illustrated in FIG. 4, explained in greater detail below.

Turning now to FIG. 2, illustrated is a representative architecture of a suitable backend component, i.e., a controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image processor, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Referring now to FIG. 4, illustrated is a representative architecture of a suitable server 400, shown in FIG. 1 as the network storage server 118, on which operations of the subject system are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by the processor 402.

A storage interface 408 suitably provides a mechanism for volatile, bulk or long term storage of data associated with the server 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the server 400 to communicate to other devices. The network interface subsystem 410 suitably interfaces with one or more connections with external devices to the server 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network subsystem 410 is suitably accomplished via a bus data transfer mechanism, such as illustrated by bus 412.

Suitable executable instructions on the server 400 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 422 as will be appreciated by one of ordinary skill in the art.

In operation, a plurality of electronic documents are first received. Unique tag data is then generated associated with each received electronic document. Preferably, each unique tag data includes data identifying the electronic document associated with the tag. Each of the documents is then monitored for the occurrence of an event. When an event occurs, event data, representing the occurrence, is generated. A data log is then generated including the tag data and the event data corresponding to received electronic documents. Thereafter, the log data is output.

In accordance with one example embodiment of the subject application, a plurality of electronic documents is first received by a suitable device. The skilled artisan will appreciate that the document processing device 104, the user device 114, the network server 118, or other similar device communicatively coupled to the computer network 102 are equally capable of receiving the plurality of electronic documents. Unique tag data is then generated associated with each received electronic document. It will be understood by those skilled in the art that the document processing device 104, the user device 114, the server 118, or the like, are each capable of generating the tag data, depending upon which has received the documents for which a tag is being generated. Preferably, the document processing device 104, via the controller 108, or other suitable backend component thereof, generates the unique tag data for each electronic document received. In accordance with the preferred embodiment of the subject application, each unique tag data includes data identifying an associated electronic document. In such an embodiment, the tag data further includes data representative of a storage location associated with the electronic document, including, for example and without limitation, a file directory, a uniform resource locator, an html or xml reference, or the like.

The controller 108, or other suitable backend component of the document processing device 104, the user device 114, or the server 118, depending upon which device received the electronic documents, then monitors usage events associated with each electronic document. The skilled artisan will appreciate that the monitoring of events includes, for example and without limitation, monitoring access to the electronic documents, monitoring output to an associated document processing device, or the like. Thus, for example and without limitation, the server 118 monitors each event associated with the electronic documents, inclusive of electronic images, stored in the data storage device 120. When an electronic document or image is accessed or output to the document processing device 104, event data is generated by the server 118. Similarly, when an electronic document is accessed or output by the document processing device 104 from the data storage device 110, event data is generated by the controller 108 or other suitable backend component. The skilled artisan will appreciate that event data is also generated when the electronic documents, inclusive of electronic images, are stored on the user device 114 and output to the document processing device 104 or accessed by an associated user.

A data log is then generated inclusive of the tag data and the event associated with each document for which an event has occurred. This data log is generated, as will be appreciated by those skilled in the art, by the controller 108, the user device 114, the server 118, or the like. In accordance with one embodiment of the subject application, the controller 108, user device 114, server 118, or the like, is capable of periodically archiving the generated data log. That is, the device 108, 114, or 118 periodically archives a generated data log and transmits the archived log to a suitable data storage. For example, when the controller 108 determines that a predetermined period of time has elapsed, the controller 108 archives the data log that has been generated and transmits the archive to storage, i.e., to the data storage device 110, or alternatively, to a remote data storage, such as the data storage device 120 associated with the server 118. It will be appreciated by those skilled in the art that such an embodiment enables multiple document processing devices (not shown) communicatively coupled to the computer network 102 to transmit logs to a central repository, i.e., the server 118, whereupon a network administrator, or the like, is able to selectively monitor each document processing device and/or each electronic document or image on the computer network 102.

In the event that archival is not warranted at the present time, or that the archived log has already been transmitted to the designated storage location, the log data is output by the device, e.g., 104, 114, 118, or the like. The log data is then analyzed to determine whether the usage, corresponding to the event detected, is acceptable. That is, the controller 108, user device 114, server 118, or other recipient of the log data determines whether the usage that prompted recordation was acceptable. The skilled artisan will appreciate that suitable usage is capable of being determined based upon parameters set forth by a network administrator, by the document creator, by the computer network 102, the type of document, or the like. Thus, when an unacceptable usage is detected, such as an attempt to print a document that was designated non-printable, a notification signal is generated to alert the responsible party of the unacceptable usage event. When the usage is acceptable, the system returns to monitoring for usage events associated with each document, as set forth above.

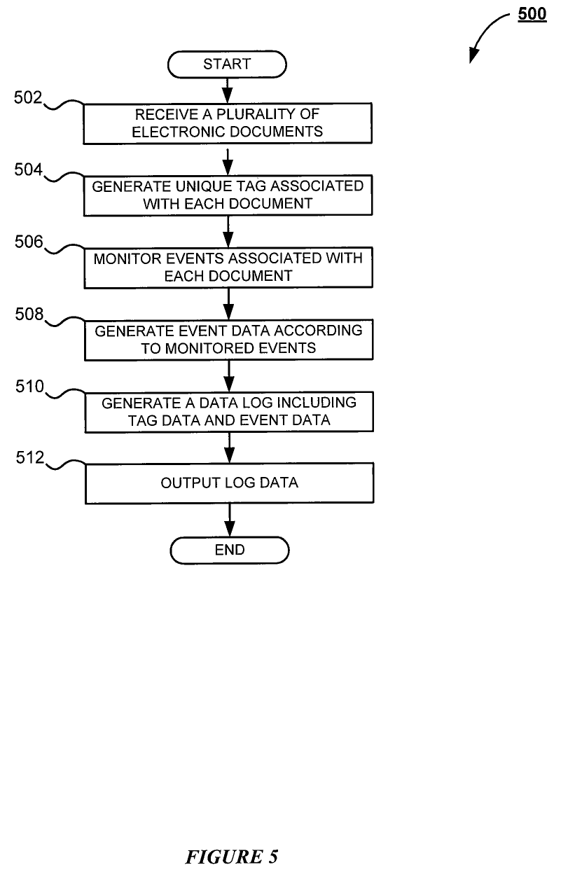

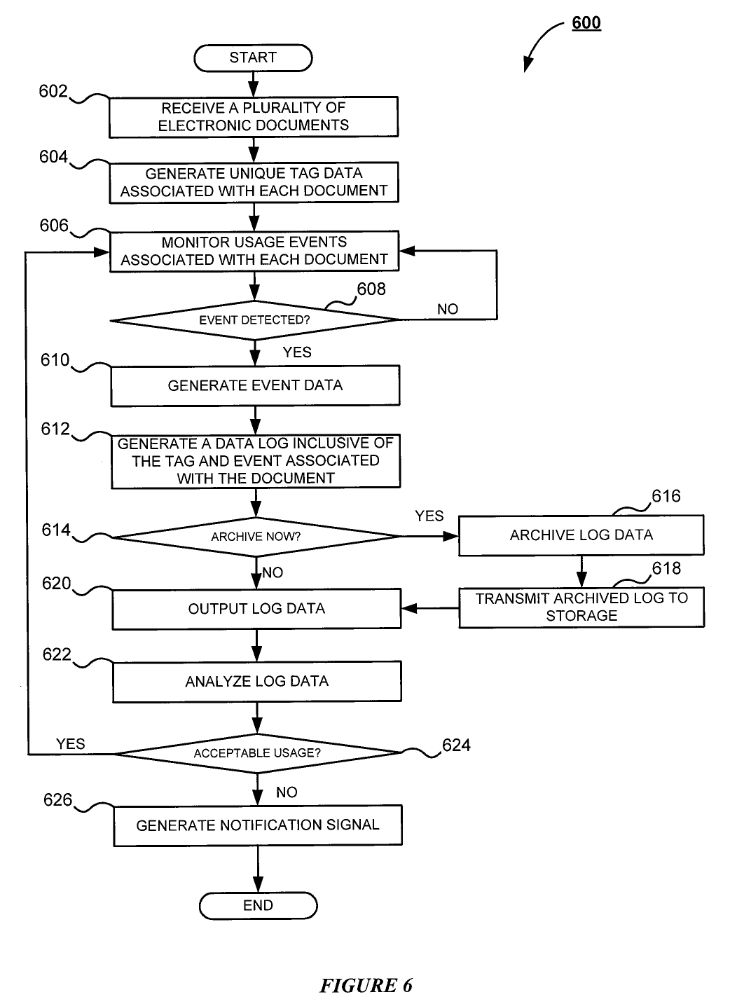

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for logging electronic images in accordance with one embodiment of the subject application. Beginning at step 502, a plurality of electronic documents are received. It will be appreciated by those skilled in the art that the receipt of the electronic documents is capable of being accomplished by the document processing device 104, the user device 114, the server 118, or the like. For purposes of explanation only, reference will be made hereinafter to receipt of the electronic documents by the document processing device 104, however the skilled artisan will appreciate that other devices coupled to the computer network 102 are equally capable of being employed in accordance with varying embodiments of the subject application.

The controller 108, or other suitable backend component associated with the document processing device 104, then generates, at step 504, unique tag data associated with each electronic document. The controller 108 then monitors, at step 506, events associated with each document. The skilled artisan will appreciate that suitable events include, for example and without limitation, access of the document, output of the document, attempted deletion or modification of the document, or the like. Event data is then generated in accordance with events monitored by the controller 108 at step 508. That is, the controller 108 monitors each event that occurs with respect to one of the received documents, and generates event data correspondingly. In accordance with one embodiment of the subject application, the event data includes, for example and without limitation, a uniform resource indicator syntax of the related data set, e.g., the event, the storage location of the data, and the like. The skilled artisan will appreciate that the uniform resource indicator is suitably capable of pointing to any data associated with the event. The controller 108, or other suitable backend component of the document processing device 104 then generates, at step 510, a data log including the tag data and the event data corresponding to the received electronic documents and events associated with the documents. The log data is then output at step 512 to a suitable storage facility, e.g., the server 114 and associated data storage device 120.

Referring now to FIG. 6, there is shown a flowchart 600 illustrating a method for logging electronic images in accordance with one embodiment of the subject application. The method depicted in the flowchart 600 of FIG. 6 begins at step 602, whereupon a plurality of electronic documents are received by the document processing device 104. It will be appreciated by those skilled in the art that reference is made herein to the document processing device 104 receiving the electronic documents, however it will be apparent to those skilled in the art that any suitable device, e.g., the user device 114 or the server 118, coupled to the computer network 102 is equally capable of functioning as the recipient in accordance with the method discussed in FIG. 6. At step 604, the controller 108 generates a unique tag or identifier associated with each of the received electronic documents. In accordance with one embodiment of the subject application, the tag data includes data representative of the storage location of the associated electronic document, including, for example and without limitation, a file directory, a uniform resource locator, an html or xml reference, or the like. The controller 108 then monitors the usage events associated with each electronic document at step 606. For example, the document processing device 104 stores the electronic documents, inclusive of any electronic images, in the data storage device 110 and then monitors the documents or images for events associated therewith. According to one embodiment of the subject application, the server 118, via the data storage device 120, stores the plurality of documents or images and the controller 108 or server 118 is tasked with monitoring those stored files for event occurrences.

A determination is then made at step 608 whether an event is detected by the monitoring device, e.g., the controller 108. It will be understood by those skilled in the art that while reference is made herein to the controller 108 monitoring the electronic documents or images, a suitable software application, ASIC, hardware, or suitable combination thereof, is also capable of implementation to function as the monitoring entity. When no events have been detected, flow returns to monitoring for usage events at step 606. When an event is detected at step 608, operations proceed to step 610, whereupon event data is generated by the controller 108. Preferably the event data includes the type of event that has occurred, e.g., an access attempt, an output attempt, or the like. The controller 108 then generates, at step 612, a data log inclusive of the tag data and the event data associated with the electronic document or image.

A determination is then made at step 614 whether to archive the data log. That is, the controller 108 determines whether a predetermined period of time has elapsed requiring the external archiving of the data log. When archiving is necessitated, flow proceeds to step 616, whereupon the log data is archived. The archived log is then transmitted, via the computer network 102, to storage at step 618. Preferably, the archived log is sent via a suitable protocol, such as, for example and without limitation syslog protocol, SNMP protocol, or the like. In accordance with one embodiment of the subject application, the archived data is transmitted to the server 118, which functions as a central storage facility, via the data storage device 120, storing archived data logs corresponding to document processing devices, user devices, or the like, communicatively coupled to the computer network 102. In the event that archiving is not warranted, or after archiving has completed, flow proceeds to step 620, whereupon the log data is output by the controller 108. It will be appreciated by those skilled in the art that the output log data is capable of being viewed by a suitable network administrator, a document creator, or the like.

At step 622, the log data is analyzed by the controller 108 or other suitable component of the system 100 to determine whether the usage event that prompted logging is an acceptable usage of the electronic image or document. When the usage of the document or image, i.e., the access or output of the document, is acceptable, flow returns to step 606, whereupon the controller 108 continues monitoring the electronic documents or images for usage events. When the usage is determined to be not acceptable by the controller, flow proceeds to step 626, whereupon a notification signal is generated. It will be appreciated by those skilled in the art that suitable notification signals include, for example and without limitation, a text alert, and electronic mail message, a visual cue, an audible sound, or the like. Preferably, the creator of the image or document, or other suitable user, e.g., an administrator, receives the notification signal. In accordance with one embodiment of the subject application, the determination of an acceptable usage is based upon predefined parameters. Thus, when the parameters are exceeded, a notification is issued. It will be appreciated by those skilled in the art that such parameters are capable of being based on, for example and without limitation, the type of image or document, an author's settings, a user's access rights, or other such bases. For example, when the author accesses the document, it is deemed an acceptable usage, however when another user of the computer network 102 attempts to access the document, the notification is issued. Similarly, when a document of a certain type which is not allowed to be output is accessed and a hardcopy is requested via the document processing device, a notification signal is sent to the concerned party.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. An electronic image logging system comprising:
means adapted for receiving a plurality of electronic documents;
tag generation means adapted for generating unique tag data associated with each received electronic document, wherein each unique tag data includes data identifying an electronic document associated therewith;
monitoring means adapted for monitoring an event associated with each of the plurality of electronic documents;
means adapted for generating event data in accordance with an output of the monitoring means;
means adapted for generating a data log inclusive of tag data and event data corresponding to a plurality of received electronic documents and events associated therewith; and
output means adapted for outputting log data.

2. The electronic image logging system of claim 1 wherein the monitoring means includes means adapted for monitoring usage that includes access to received electronic documents inclusive of electronic images.

3. The electronic image logging system of claim 2 wherein the monitoring means further includes means adapted for monitoring usage that includes output of received electronic images to an associated document processing device.

4. The electronic image logging system of claim 2 further comprising analyzing means adapted for analyzing the data log in accordance with selected parameters to determine acceptability of usage.

5. The electronic image logging system of claim 4 further comprising means adapted for generating a notification signal upon a determination of unacceptable usage by the analyzing means.

6. The electronic image logging system of claim 2 further comprising means adapted for periodically archiving a generated data log.

7. The electronic image logging system of claim 1 wherein the tag data includes data representation of a storage location of an electronic document associated therewith.

8. A method for logging electronic images comprising the steps of:
receiving a plurality of electronic documents;
generating unique tag data associated with each received electronic document, wherein each unique tag data includes data identifying an electronic document associated therewith;
monitoring an event associated with each of the plurality of electronic documents;
generating event data in accordance with an output of the monitoring step;
generating a data log inclusive of tag data and event data corresponding to a plurality of received electronic documents and events associated therewith; and
outputting log data.

9. The method for logging electronic images of claim 8 wherein the step of monitoring includes monitoring usage that includes access to received electronic documents inclusive of electronic images.

10. The method for logging electronic images of claim 9 wherein the step of monitoring includes monitoring usage that includes output of received electronic images to an associated document processing device.

11. The method for logging electronic images of claim 9 further comprising the step of analyzing the data log in accordance with selected parameters to determine acceptability of usage.

12. The method for logging electronic images of claim 11 further comprising the step of generating a notification signal upon a determination of unacceptable usage.

13. The method for logging electronic images of claim 9 further comprising the step of periodically archiving a generated data log.

14. The method for logging electronic images of claim 7 wherein the tag data includes data representation of a storage location of an electronic document associated therewith.

15. A computer-implemented method for logging electronic images comprising the steps of:
receiving a plurality of electronic documents;
generating unique tag data associated with each received electronic document, wherein each unique tag data includes data identifying an electronic document associated therewith;
monitoring an event associated with each of the plurality of electronic documents;
generating event data in accordance with an output of the monitoring step;
generating a data log inclusive of tag data and event data corresponding to a plurality of received electronic documents and events associated therewith; and
outputting log data.

16. The computer-implemented method for logging electronic images of claim 15 wherein the step of monitoring includes monitoring usage that includes access to received electronic documents inclusive of electronic images.

17. The computer-implemented method for logging electronic images of claim 16 wherein the step of monitoring includes monitoring usage that includes output of received electronic images to an associated document processing device.

18. The computer-implemented method for logging electronic images of claim 16 further comprising the steps of analyzing the data log in accordance with selected parameters to determine acceptability of usage and generating a notification signal upon a determination of unacceptable usage.

19. The computer-implemented method for logging electronic images of claim 16 further comprising the step of periodically archiving a generated data log.

20. The computer-implemented method for logging electronic images of claim 15 wherein the tag data includes data representation of a storage location of an electronic document associated therewith.
